(19) United States
(12) Patent Application Publication
(10) Pub. No.: US 2008/0124144 A1
(43) Pub. Date: May 29, 2008

(54) FIXING APPARATUS AND IMAGE FORMING APPARATUS

(76) Inventors: Takashi MUKAI, Yamatokoriyama-shi (JP); Toshiaki KAGAWA, Kitakatsuragi-gun (JP); Hiroshi Kida, Yamatokoriyama-shi (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/945,301

(22) Filed: Nov. 27, 2007

(30) Foreign Application Priority Data
Nov. 29, 2006 (JP) 2006-322487

(51) Int. Cl. G03G 15/20

(52) U.S. Cl. 399/327

(57) ABSTRACT

A fixing apparatus is provided that includes a fixing section, a pressure section, and an external heating section, the fixing apparatus being adaptable to an increase in image forming process speed, in which fixing apparatus, the fixing section, the external heating section, and the like section can be sufficiently cleaned without addition of another cleaning section, a growth in size of the fixing apparatus, nor a drastic increase in a manufacturing cost. In an image forming apparatus provided with a fixing apparatus which includes a fixing roller, a pressure roller, an external heating section, and a cleaning section having a cleaning web, the cleaning web is disposed in pressure-contact with the external heating section by tension of the cleaning web.

### CROSS-REFERENCE TO RELATED APPLICATION

This application claims priority to Japanese Patent Application No. 2006-322487, which was filed on Nov. 29, 2006, the contents of which are incorporated herein by reference in its entirety.

### BACKGROUND OF THE INVENTION

1. Field of the Invention

The present invention relates to a fixing apparatus and an image forming apparatus.

2. Description of the Related Art

An electrophotographic image forming apparatus is capable of forming a high-quality image with favorable reproducibility and operability at low cost. This is why the electrophotographic image forming apparatus has been widely used in a copier, a printer, a facsimile machine, a multifunction machine having two or more of these functions just stated, and the like machine. The electrophotographic image forming apparatus includes, for example, a photoreceptor, a charging section, an exposing section, a developing section, a transfer section, and a fixing section. The photoreceptor is a member on whose surface an electrostatic latent image corresponding to image information is formed. The charging section serves to charge a surface of the photoreceptor. The exposing section serves to irradiate the charged surface of the photoreceptor with signal light to thereby form an electrostatic latent image. The developing section serves to supply a toner to the electrostatic latent image formed on the surface of the photoreceptor, to thereby form a toner image. The transfer section serves to transfer the toner image formed on the surface of the photoreceptor to a recording medium. The fixing section serves to fix the toner image on the recording medium to thereby form an image.

For the fixing section, a fixing apparatus including a fixing roller and a pressure roller is generally used. The fixing roller contains a heating portion therein which generates heat to fuses the toner constituting the toner image not yet fixed on the recording medium so that the toner image is fixed on the recording medium. The pressure roller is disposed in pressure-contact with the fixing roller, and presses the recording medium onto the fixing roller when the toner is heated to be fused by the fixing roller, thereby promoting the fixing of the toner onto the recording medium. A pressure-contact area between the fixing roller and the pressure roller is named a fixing nip portion. The recording medium bearing the not-yet-fixed toner image is introduced to the fixing nip portion with a toner image bearing surface of the recording medium in contact with the surface of the fixing roller. At the fixing nip portion, the not-yet-fixed toner image is fixed by heat and pressure. Moreover, in the fixing apparatus as just described, an offset toner which remains on the surface of the fixing roller is removed by a cleaning section. The cleaning section includes, for example, a cleaning web (hereinafter referred to simply as “web”), a feeding roller, a pressure-contact roller, and a winding roller. The web comes into pressure-contact with the surface of the fixing roller to thereby remove the offset toner. The feeding roller serves to reel out the web. The pressure-contact roller serves to bring the web into pressure-contact with the surface of the fixing roller. The winding roller is driven to rotate with a driving force given by a driving mechanism, thereby taking up the web. In the cleaning section, the winding roller is driven to rotate, which drives the feeding roller to reel out the web, and the web is brought into contact with the surface of the fixing roller, thereby removing the offset toner, and thereafter moved off from the fixing roller.

Generally, as the fixing roller and the pressure roller in the fixing apparatus used for the color image forming apparatus, a roller is used which contains a cylindrical metal core, a 0.5 mm to 3 mm-thick heat-resistant elastic layer formed on a surface of the metal core, and a 15 μm to 70 μm-thick surface layer formed on a surface of the heat-resistant elastic layer. A material used for the metal core is a metal such as aluminum and stainless steel. The heat-resistant elastic layer is made of a rubber material such as silicone rubber. The surface layer is made of fluorine resin such as polytetrafluoroethylene (PTFE) and a tetrafluoroethylene-perfluoroalkylvinylether copolymer (PFA). The fluorine resin is excellent in a mold-releasing property and a separability property from the recording medium, therefore decreasing the attachment of the offset toner onto the fixing roller and preventing the recording medium which has already passed through the fixing nip portion, from winding around the fixing roller or the like component. In the image forming apparatus employing the fixing roller as described above, heat is conducted away from the fixing roller and the pressure roller by the recording medium when the recording medium passes through the fixing nip portion, resulting in a tendency of abrupt decreases in surface temperatures of the fixing roller and the pressure roller. Since the fixing roller contains the heating portion therein, heat is supplied by the heating portion in response to detection of the decrease of the surface temperature of the fixing roller. It however requires a long time until the temperature of the fixing roller rises up to an adequate temperature range because the rubber material constituting the heat-resistant elastic layer is lower in thermal conductivity than metal. Accordingly, continuous image formation easily causes the toner image to suffer from defective fixing due to the decrease of the surface temperature of the fixing roller or the like component. The defective fixing appears more significantly with a higher speed in the image forming process, and it is thus difficult to speed up the image forming process in the color image forming apparatus.

In view of the above problems, the following fixing apparatuses have been proposed, for example. One example is a fixing apparatus which includes a fixing roller and an external heating section disposed in contact with a surface of the fixing roller (refer to Japanese Unexamined Patent Publication JP-A 10-301417 (1998), for example). Another example is a fixing apparatus which includes a fixing roller and an external heating section that is in contact with a surface of the fixing roller and disposed at such a position as to be able to heat a recording medium bearing a not-yet-fixed toner image (refer to Japanese Unexamined Patent Publication JP-A 11-73050 (1999), for example). Both of the fixing apparatuses are characterized in that the external heating section is provided in contact with the surface of the heating roller in order to prevent the temperature of the surface of the fixing roller from lowering at a rapid rate. In these fixing apparatuses, when the roller having a fluorine resin-made surface layer as described above is used for the fixing roller and the pressure roller, a surface of the external heating section is more likely to suffer from attachment of the offset toner which remains on the surface of the fixing roller even through the cleaning section. This particularly shortens a service life of the external heating section. Further, the toner attached to the external heating section may be attached back to the fixing roller, which causes image defects. The external heating section thus requires a surface which is higher in the mold-releasing property than the fixing roller and the pressure roller so that the offset toner is prevented from being attached to the surface of the external heating section. At present, however, in order to obtain a material which is higher in the mold-releasing property than the fluorine resin, it is necessary to treat the material with a special process, etc. for improving the mold release. This makes it very difficult to apply these fixing apparatuses on an industrial scale from not only a technical aspect, but also a cost aspect.

As an alternative idea, the external heating section may have a surface layer made of the fluorine resin. In this case, it is necessary to use a fixing roller whose surface is lower in the mold-releasing property than the fluorine resin in order to prevent the offset toner from being attached to the external heating section. The use of the fixing roller just mentioned however causes the recording medium which has passed through the fixing nip portion, to easily wind around the fixing roller. Although the installation of a cleaning section only for the external heating section enables the use of the fixing roller having the fluorine resin-made surface layer, it is inevitable that the image forming apparatus will be larger and the manufacturing cost will increase significantly.

In view of the above problems, a configuration has been proposed that the cleaning section used for removing the offset toner from the fixing roller is used also for cleaning the external heating section. For example, a fixing apparatus shown in FIG. 8 has been proposed (refer to Japanese Unexamined Patent Publication JP-A 11-45023 (1999), for example). FIG. 8 is a sectional view schematically showing a configuration of a fixing apparatus 100. The fixing apparatus 100 includes a fixing roller 101, a pressure roller 102, a first external heating roller 103, a second external heating roller 104, a first cleaning section 105, and a second cleaning section 106. The first cleaning section 105 includes a first web 110, a first feeding roller 111, a fixing pressure-contact roller 112, a first heating pressure-contact roller 113, and a first winding roller 114. The first web 110 is impregnated with a sufficient amount of a release agent. The first web 110 which is fed from the first feeding roller 111 driven by rotation of the first winding roller 113, is hung around the fixing pressure-contact roller 112 to be in pressure-contact with the fixing roller 101, thereby cleaning a surface of the fixing roller 101 and applying the release agent to the surface. This secures the fixing roller 101 the separability property from a recording medium. Next, the first web 110 is hung around two assist rollers 120 and 121 and then hung around the first heating pressure-contact roller 113 to be in pressure-contact with the first external heating roller 103. At the time, a surface of the first web 110 in pressure-contact with the first external heating roller 103 is opposite to a surface of the first web 110 in pressure-contact with the fixing roller 101. The first web 110 thus cleans the first external heating roller 103. Subsequently, the first web 110 is taken up by the first winding roller 114. The second cleaning section 106 includes a second web 115, a second feeding roller 116, a pressurizing pressure-contact roller 117, a second heating pressure-contact roller 118, and a second winding roller 119. A configuration of the second cleaning section 106 is the same as that of the first cleaning section 105. The fixing apparatus disclosed in JP-A 11-45023 employs the configuration that the fixing roller is cleaned by a surface of the web while the external heating section is cleaned by a rear surface of the web. This can thus achieve a lower manufacturing cost compared to the case of providing the cleaning section only for the external heating section. Moreover, the cleaning of the external heating section as well eliminates the need to make a difference in the mold-releasing property between the surface of the fixing roller, etc. and the surface of the external heating section. As a matter to be considered, there thus remains only the separability property of the fixing roller, etc. for the recording medium. It is therefore possible to refrain from using an expensive material. In other words, the cost for whole fixing apparatus can be reduced.

The cleaning property is however low because the rear surface of the web is liable to be flossy due to manufacturing problems of the web. Accordingly, in the technique disclosed in JP-A 11-45023, the external heating section may be insufficiently cleaned. Moreover, in the design that the both surfaces of the web respectively contact with the fixing roller and the external heating section, a suspension structure of the web is very complex, leading to an increase in size of the fixing apparatus. In addition, the configuration of cleaning the external heating section by the web which has cleaned the very soiled fixing roller, may cause the web to make contact unevenly and unstably with the external heating section due to the toner attached from the fixing roller to the web, leading to defective cleaning. Further, when a belt-like external heating section is used, the belt may go into a skid, failing to sufficiently heat the fixing roller, because the configuration is employed that the web is pressed onto the external heating section with use of backup rollers (the first heating pressure-contact roller 113 and the second heating pressure-contact roller 118). Furthermore, when a thermistor necessary for temperature control, a thermostat necessary for security, and the like component are disposed, the external heating section has a larger diameter, leading to the increase in size of the fixing apparatus again in this point, because the constitution is employed that the web is brought into contact with the roller-shaped external heating section.

### SUMMARY OF THE INVENTION

An object of the invention is to provide a fixing apparatus including a fixing section, a pressure section, and an external heating section, in which fixing apparatus, the fixing section, the external heating section, and the like section can be sufficiently cleaned without addition of another cleaning section, a growth in size of the fixing apparatus, nor a drastic increase in a manufacturing cost caused by using a special material, etc., and to provide an image forming apparatus having the fixing apparatus described above.

The invention provides a fixing apparatus comprising:

a fixing section disposed so as to be rotatable about an axis thereof, for fixing an unfixed toner image onto a recording medium by heating the recording medium bearing the unfixed toner image;

a pressure section disposed in pressure-contact with the fixing section so as to form a pressure-contact area therebetween, for pressurizing a recording medium bearing the unfixed toner image which is conveyed to the pressure-contact area;

an external heating section disposed so as to contact with a peripheral surface of the fixing section or the pressure section from outside, for heating the peripheral surface; and

a cleaning section including at least a cleaning web for cleaning a surface of the fixing section or the pressure section by contacting with the surface, a feeding roller for reeling out the cleaning web, a web pressure-contact roller rotatably supported, for bringing the cleaning web into pressure-contact with the fixing section or the pressure section, and a winding roller for taking up the cleaning web which has come into pressure-contact with the fixing section or the pressure section,

wherein the cleaning web contacts with the external heating section by being pressed thereon in a state where the cleaning web is tensioned between the feeding roller and the web pressure-contact roller.

According to the invention, a fixing apparatus is provided which includes a fixing section, a pressure section, an external heating section, and a cleaning section. In the fixing apparatus of the invention, the external heating section is disposed so as to contact with a peripheral surface of the fixing section or the pressure section from outside thereof, thereby heating the peripheral surface. Further, the cleaning section includes a cleaning web (hereinafter referred to simply as “web” unless otherwise specified), a feeding roller, a web pressure-contact roller for bringing the web into pressure-contact with a surface of the fixing roller, and a winding roller. The web is tensioned between the feeding roller and the winding roller, and in this state, pressed onto the external heating section, thereby contact with the external heating section. There is thus no need to use a pressure-contact member such as a pressure-contact roller for bringing the web into pressure-contact with the external heating section. Moreover, the web contacts with both of the fixing section and the external heating section or both of the pressure section and the external heating section. There is thus no need to provide a cleaning section only for the external heating section. Accordingly, as compared to the conventional fixing apparatus, the fixing apparatus of the invention enables efficient cleaning of the fixing section or pressure section, the external heating section, and the like component, only by somewhat modifying an arrangement of the external heating section relative to the cleaning section. In addition, the fixing apparatus of the invention enables reduction in size and manufacturing cost of the fixing apparatus since the fixing apparatus of the invention does not employ the cleaning section only for the external heating section and the member for bringing the web into pressure-contact with the external heating section, both of which are provided in the conventional fixing apparatus. Further, no need of the member for bringing the web into pressure-contact with the external heating section increases a degree of design freedom for the external heating section. For example, an endless belt may be tensioned between a plurality of the heating rollers, and an external heating section may be used that is adapted to use the endless belt to heat the fixing section. Even in such a case, the absence of the pressure-contact member enables reduction in load on the belt at a contact area between the belt and the web. As a result, the belt is prevented from going into a skid and thus able to be cleaned efficiently.

Further, in the invention, it is preferable that the external heating section comprises a heating roller which is disposed in pressure-contact with the fixing section or the pressure section.

According to the invention, in the case of using the external heating section which includes a heating roller disposed in pressure-contact with the fixing section or the pressure section, both of the fixing section and the external heating section or both of the pressure section and the external heating section can be efficiently cleaned without an increase in size of the fixing apparatus even when the fixing apparatus is composed of the same constituent members as those of the conventional fixing apparatus. In this regard, the fixing apparatus of the invention is distinctly superior to the convention fixing apparatus.

Further, in the invention, it is preferable that the external heating section comprises a belt member which is disposed in pressure-contact with the fixing section or the pressure section.

According to the invention, in the case of using the external heating section which includes a belt member disposed in pressure-contact with the fixing section or the pressure section, the fixing section or the pressure section can be efficiently heated without an increase in size of the fixing apparatus by, for example, adjusting a contact area of the belt member with the fixing section or pressure section. Further, the use of the belt member enhances the degree of design freedom for the external heating section to a large extent. For example, an endless belt may be used for the belt member, and tensioned between a plurality of roller members. In such a case, a heating device such as a thermistor and a thermostat can be arranged within a region surrounded by the endless belt by adjusting a spaced distance between the roller members. Moreover, the endless belt does not go into a skid at a contact area between the endless belt and the web. In addition, the enhancement in degree of design freedom for the external heating section also contributes to prevention of an increase in size of the fixing apparatus.

Further, in the invention, it is preferable that the cleaning web is arranged so that one surface thereof contacts with the fixing section and the external heating section or the pressure section and the external heating section.

According to the invention, the web is arranged so that one surface (preferably, unflossy surface) of the web contacts with both of the fixing section and the external heating section or both of the pressure section and the external heating section, thereby allowing prevention of decrease in cleaning performance of the web and defective cleaning caused by the decrease.

Further, in the invention, it is preferable that the cleaning web is arranged so as to contact with the fixing section or the pressure section upstream of the external heating section in a rotational direction of the fixing section or the pressure section.

According to the invention, the web is arranged so as to contact with the fixing section or the pressure section upstream of the external heating section in a rotational direction of the fixing section or the pressure section, thereby achieving such an arrangement that the fixing section or pressure section and the external heating section are in contact with each other, which enables a further enhancement in efficiency of heating effected by the external heating section. That is to say, in the configuration, the web cleans the surface of the fixing section or pressure section before the fixing section or pressure section and the external heating section contact with each other, thus allowing a significant decrease in attachment of the toner from the fixing section or the pressure section onto the external heating section. This makes an arrangement possible that the fixing section or pressure section and the external heating section are in contact with each other.

Further, in the invention, it is preferable that the cleaning web is arranged so as to contact with the external heating section and then contact with the fixing section or the pressure section.

According to the invention, the web is arranged so as to contact with the external heating section and then contact with the fixing section or the pressure section, thereby enabling efficient cleaning of the external heating section and the fixing section or the pressure section. Since the external heating section is intrinsically not very contaminated, the fixing section or the pressure section is not contaminated by the web which has contacted with the external heating section before contacting with the fixing section or the pressure section. Consequently, the fixing section or the pressure section can be cleaned sufficiently.

Further, in the invention, it is preferable that the cleaning web is arranged so as to contact with the fixing section or the pressure section in downstream of the external heating section in a rotational direction of the fixing section or the pressure section.

According to the invention, the web can be arranged so as to contact with the fixing section or the pressure section in downstream of the external heating section in a rotational direction of the fixing section or the pressure section. Also in this case, the arrangement is possible that the fixing section or pressure section and the external heating section are in contact with each other, which enables a further enhancement in efficiency of heating effected by the external heating section.

Further, in the invention, it is preferable that the cleaning web is arranged so as to contact with the fixing section or the pressure section and then contact with the external heating section.

According to the invention, in the case of arranging the web so as to contact with the fixing section or the pressure section in downstream of the external heating section in a rotational direction of the fixing section or the pressure section, the web is preferably adapted to contact with the fixing section or the pressure section and then contact with the external heating section. In this case, when the fixing section or the pressure section and the external heating section are brought into contact with each other, the fixing section or the pressure section is cleaned to some extent by the external heating section, and the toner is shifted from the surface of the fixing section or pressure section to the surface of the external heating section, thus resulting in attachment of the toner onto the surface of the external heating section. That is to say, an amount of the toner attached to the surface of the fixing section or pressure section becomes smaller, and to the surface of the external heating section is attached the toner of which amount becomes larger than the amount of the toner attached to the surface of the fixing section or pressure section. In this state, the web is brought into contact with the fixing section or the pressure section and then brought into contact with the external heating section. This enables sufficient cleaning of the surface of the fixing section or pressure section. Moreover, the web which has contacted with the fixing section or the pressure section, maintains sufficient cleaning capability because an amount of the toner adsorbed by the web is small. This enables also cleaning of the surface of the external heating section. Consequently, the arrangement is possible that the fixing section or pressure section and the external heating section are in contact with each other, which enables a further enhancement in efficiency of heating effected by the external heating section.

Further, in the invention, it is preferable that the cleaning web is arranged so that a contact area between the cleaning web and the external heating section increases as an amount of the cleaning web taken up by the winding roller increases.

According to the invention, the feeding roller is preferably adapted to feed the web so that a contact area between the cleaning web and the external heating section increases as an amount of the web taken up by the winding roller increases. A long-time use of the fixing apparatus will gradually deteriorate the mold-releasing property of the surface of the external heating section. The deterioration in the mold-releasing property of the external heating section can be thus compensated by such an arrangement of the web that the contact area between the web and the external heating section gradually becomes larger. By so doing, a favorable fixing operation is carried out until the end of service life of the fixing apparatus. A specific example of how to increase the contact area between the web and the external heating section includes adoption of a configuration that the feeding roller rotates in a counterclockwise direction to feed the web. In such a configuration, a diameter of the feeding roller including a rolled web becomes smaller as the take-up amount of the web increases, and a shaft center of the feeding roller is fixed, with the result that a feeding position where the web is fed from the feeding roller is distanced away from a contact position where the web and the external heating section contact with each other. In the meantime, the external heating section presses the web away from the fixing roller immediately after the web is fed by the feeding roller. Accordingly, as the distance is longer between the feeding position and the contact position for the web, an angle is smaller which is formed by the web and the external heating section at the contact position. As a result, the contact area between the web and the external heating section can gradually increase.

Further, the invention provides an image forming apparatus comprising:

a photoreceptor having on a surface thereof a photosensitive layer;

a charging section for charging a surface of the photoreceptor;

an exposing section for forming an electrostatic latent image by irradiating a charged surface of the photoreceptor with signal light corresponding to image information;

a developing section for forming a toner image by supplying a toner to the electrostatic latent image on the surface of the photoreceptor;

a transfer section for transferring the toner image onto a recording medium by using or not using an intermediate transfer medium; and

the fixing section mentioned above for fixing an unfixed toner image on the recording medium.

According to the invention, an electrophotographic image forming apparatus is provided which includes the fixing apparatus of the invention. In the electrophotographic image forming apparatus, high quality images can be stably formed for a long period of time without defectively fixing the image, soiling the image by attachment of the offset toner onto the recording medium, staining a rear surface of the recording medium (an underside of a surface where an image is formed), and the like adverse action, even when the image forming process speed increases. Moreover, these effects are achieved without any increase in size and manufacturing cost of the apparatus.

### BRIEF DESCRIPTION OF THE DRAWINGS

Other and further objects, features, and advantages of the invention will be more explicit from the following detailed description taken with reference to the drawings wherein:

FIG. 1 is a sectional view schematically showing a configuration of an image forming apparatus according to one embodiment of the invention;

FIG. 2 is an enlarged sectional view showing a configuration of chief part of the image forming apparatus shown in FIG. 1;

FIG. 3 is a sectional view schematically showing a configuration of a fixing apparatus according to a first embodiment of the invention;

FIG. 4 is an enlarged sectional view showing a configuration of chief part of the fixing apparatus shown in FIG. 3;

FIG. 5 is a sectional view schematically showing a configuration of a fixing apparatus according to a second embodiment;

FIG. 6 is a sectional view schematically showing a configuration of a fixing apparatus according to a third embodiment of the invention;

FIG. 7 is a sectional view schematically showing a fixing apparatus according to a fourth embodiment of the invention; and

FIG. 8 is a sectional view schematically showing a configuration of the fixing apparatus disclosed in JP-A 11-45023 (1999).

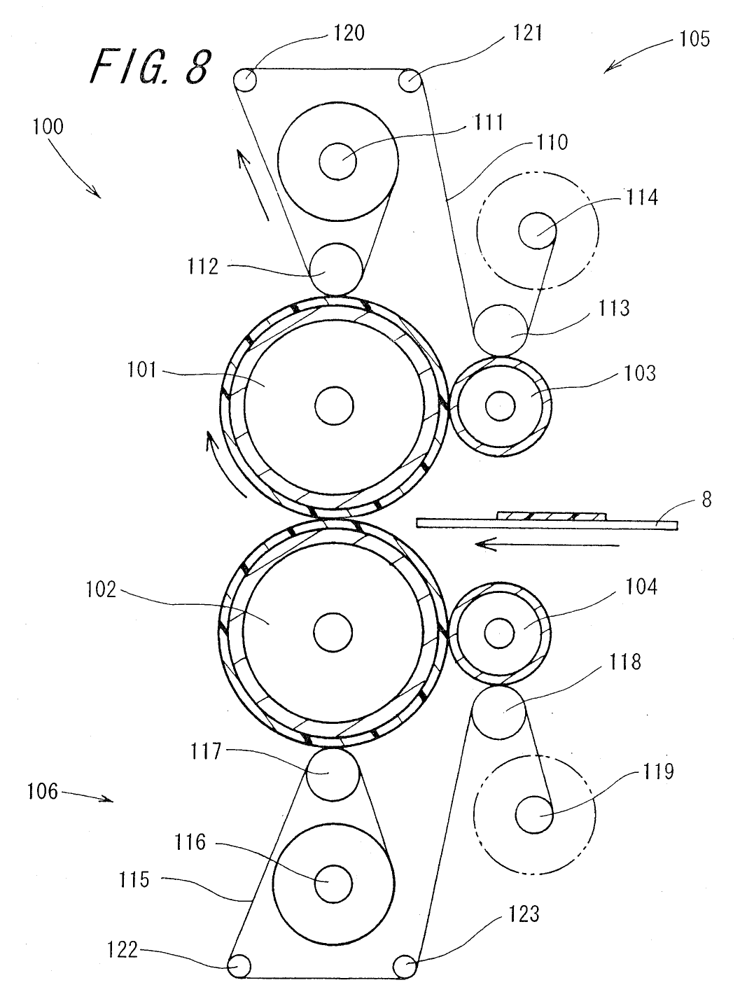

### DETAILED DESCRIPTION

Now referring to the drawings, preferred embodiments of the invention are described below.

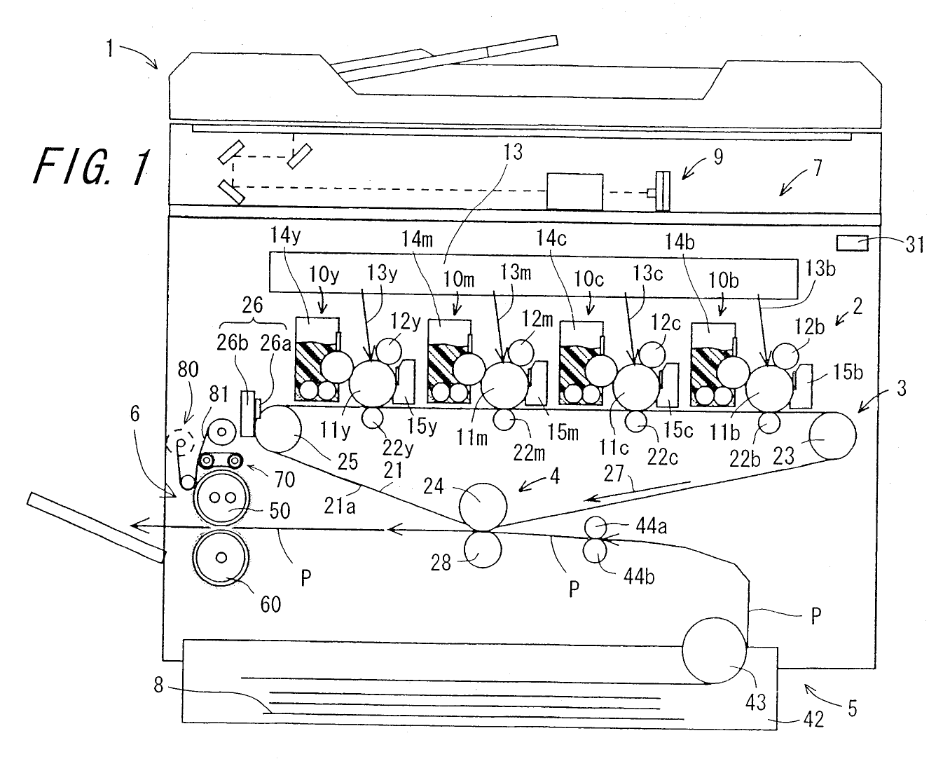

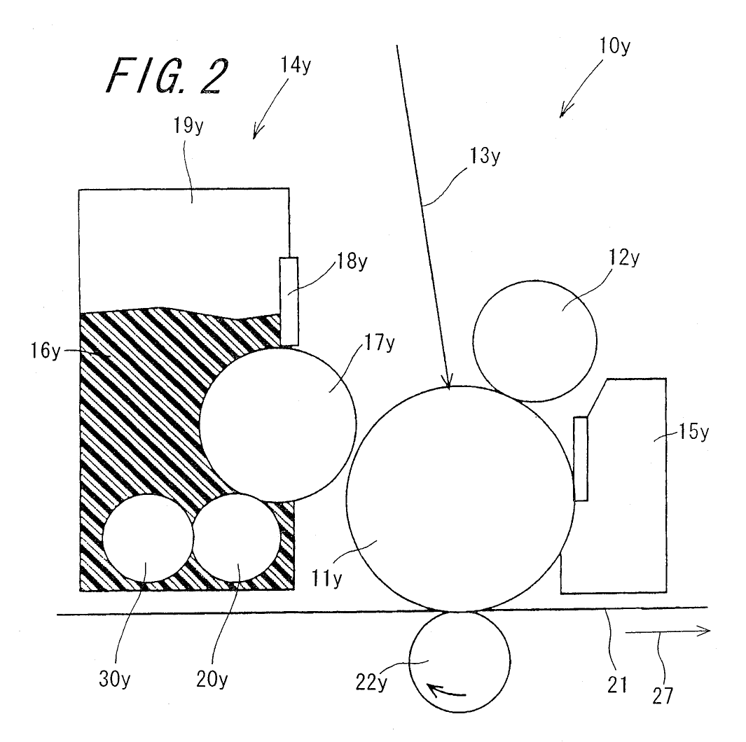

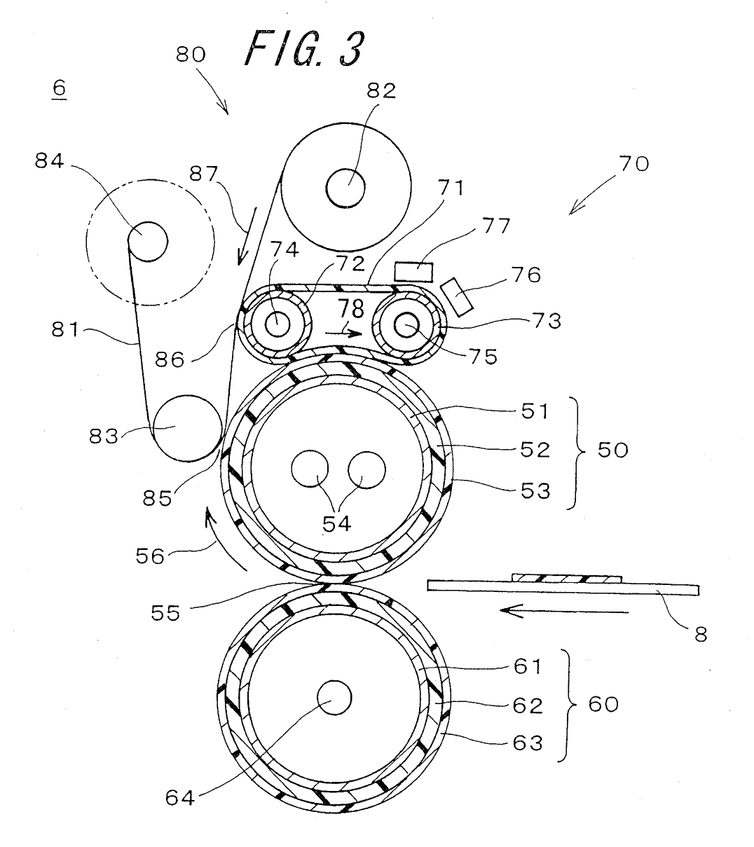

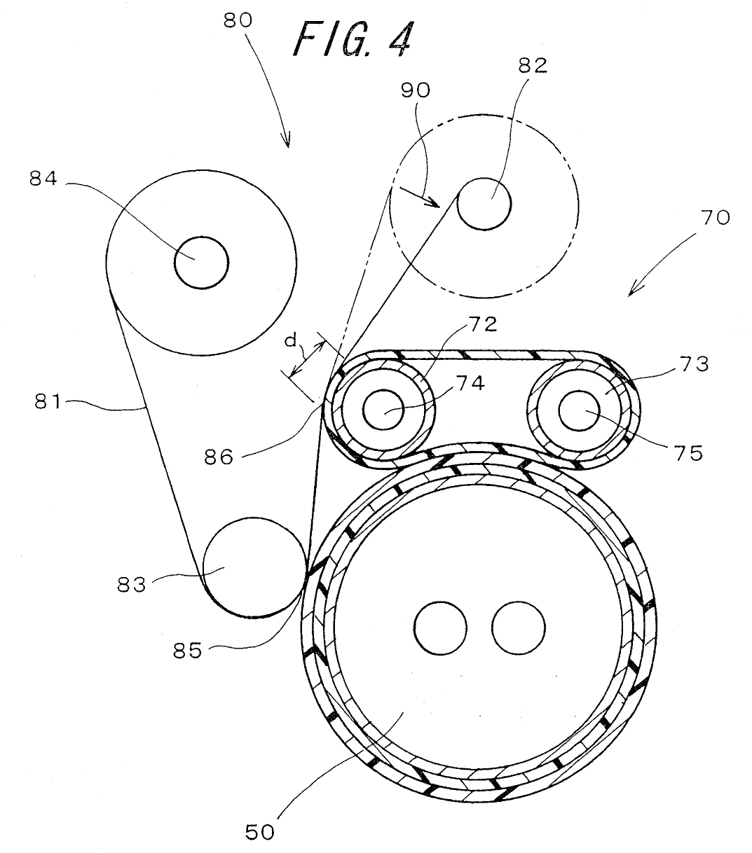

FIG. 1 is a sectional view schematically showing a configuration of an image forming apparatus 1 according to one embodiment of the invention. FIG. 2 is an enlarged sectional view showing a configuration of chief part of the image forming apparatus 1 shown in FIG. 1. FIG. 3 is a sectional view schematically showing a configuration of a fixing apparatus 6 according to a first embodiment of the invention. FIG. 4 is an enlarged sectional view showing a configuration of chief part of the fixing apparatus 6 shown in FIG. 3. The image forming apparatus 1 is an electrophotographic image forming apparatus in tandem configuration which forms an image in a manner that toner images of four colors of yellow, magenta, cyan, and black are sequentially transferred and overlaid on top of one another to thereby form a multicolor toner image, and the multicolor toner image is fixed on a recording medium. The image forming apparatus 1 includes a toner image forming section 2, an intermediate transfer section 3, a secondary transfer section 4, a recording medium supplying section 5, the fixing apparatus 6, and a scanner section 7.

The toner image forming section 2 includes image forming units 10y, 10m, 10c, and 10b. The image forming units 10y, 10m, 10c, and 10b are aligned in a row from an upstream side along a rotational direction (sub-scanning direction) of a later-described intermediate transfer belt 21, i.e., a direction of an arrow 27. The image forming units 10y, 10m, 10c, and 10b form toner images of the respective colors as follows. In the image forming units 10y, 10m, 10c, and 10b, electrostatic latent images are formed which correspond to image information of the respective colors inputted as digital signals, and toners of corresponding colors are then supplied to the electrostatic latent images to thereby develop the images. The image forming unit 10y forms a toner image corresponding to yellow image information. The image forming unit 10m forms a toner image corresponding to magenta image information. The image forming unit 10c forms a toner image corresponding to cyan image information. The image forming unit 10b forms a toner image corresponding to black image information. The image forming unit 10y includes a photoreceptor drum 11y, a charging roller 12y, a light scanning unit 13, a developing device 14y, and a drum cleaner 15y.

The photoreceptor drum 11y is a roller-shaped member that is supported so as to be rotatable about an axial line thereof by a driving mechanism (not shown) and that has a photosensitive layer on which surface the electrostatic latent image and thus the toner image are formed. The usable photoreceptor drum 11y may be composed of a conductive base (not shown) and a photoreceptor drum (not shown) formed on a surface of the conductive base. An applicable shape of the conductive base may be cylindrical, columnar, sheet-like, etc., among which cylindrical is preferable. Examples of the photosensitive layer include an organic photosensitive layer and an inorganic photosensitive layer. The organic photosensitive layer may be a laminate composed of a charge generating layer which is a resin layer containing a charge generating substance, and a charge transporting layer which is a resin layer containing a charge transporting substance, or may be a resin layer which contains a charge generating substance and a charge transporting substance in a single resin layer. The inorganic photosensitive layer may be a layer which contains one or two or more of zinc oxide, selenium, amorphous silicon, and the like substance. Between the conductive base and the photosensitive layer may be interposed an undercoat layer, and a surface of the photosensitive layer may be provided with a surface layer (a protective layer) for protecting the photosensitive layer mainly. In the present embodiment, a 30 mm-diameter photoreceptor drum is used which contains an aluminum tube (a conductive base) connected to ground potential (GND) and a 20 μm-thick organic photosensitive layer formed on a surface of the aluminum tube. Further, in the embodiment, the photoreceptor drum 11y rotates in a clockwise direction at a peripheral velocity of 355 mm/s.

The charging roller 12y is a roller-shaped member which is supported so as to be rotatable about an axial line thereof by a driving mechanism (not shown) and which charges the surface of the photoreceptor drum 11y with predetermined polarity and potential. The charging roller 12y is connected to a power source (not shown). Application of voltage by the power source to the charging roller 12y causes discharge of electricity to thereby charge the surface of the photoreceptor drum 11y. In the embodiment, voltage of −1200 V is applied to the charging roller 12y, and the surface of the photoreceptor drum 11y is thereby charged to −600 V. The charging roller 12y can be replaced by a brush-type charging device, a charger-type charging device, and a corona charging device such as a scorotron charger. The light scanning unit 13 irradiates the charged surface of the photoreceptor drum 11y with laser light 13y corresponding to yellow image information to thereby form on the surface of the photoreceptor drum 11y an electrostatic latent image corresponding to the yellow image information. For the light scanning unit 13, a semiconductor laser or the like component can be used. In the embodiment, an electrostatic latent image having an exposure potential of −70 V is formed on the surface of the photoreceptor drum 11y which surface has been charged to −600 V.

The developing device 14y includes a developing roller 17y, a developing blade 18y, a developer tank 19y, and stirring rollers 20y and 30y. Yellow developer 16y is borne on a surface of the developing roller 17y and supplied therefrom to the electrostatic latent image on the surface of the photoreceptor drum 11y at an area (named as “a developing nip portion”) where the developing roller 17y and the photoreceptor drum 11y come close to each other. The developing roller 17y is a roller-shaped member that is supported so as to be rotatable about an axial line thereof by the developer tank 19y and is disposed so as to have a part thereof protrude outward from an opening formed on a surface of the developer tank 19y which surface faces the photoreceptor drum 11y, to thereby come close to the surface of the photoreceptor drum 11y, and that internally contains a fixed magnetic pole (not shown). The developing roller 17y rotates in a direction opposite to a rotational direction of the photoreceptor drum 11y. Accordingly, at the developing nip portion, the developing roller 17y and the photoreceptor drum 11y rotate in the same direction. Further, the developing roller 17y is connected to a power source (not shown) which applies DC voltage (development voltage) to the developing roller 17y. This causes the yellow developer 16y on the surface of the developing roller 17y to be smoothly supplied to the electrostatic latent image. In the embodiment, development voltage of −420 V is applied to the developing roller 17y. An yellow toner layer on the surface of the developing roller 17y contacts with the photoreceptor drum 11y at the developing nip portion where the yellow developer 16y is thereby supplied to the electrostatic latent image. The developing blade 18y is a platy member which is provided so as to have one end supported by the developer tank 19y and the other end distanced away from the surface of the developing roller 17y. The developing blade 18y is used for homogenization (layer regulation) of the yellow toner layer borne on the surface of the developing roller 17y. The developer tank 19y is a container-shaped member which has the opening on the surface facing the photoreceptor drum 11y as described above and which has an internal space. The developer tank 19y contains the developing roller 17y and the stirring rollers 20y and 30y housed in the internal space, and stores the yellow developer 16y therein. The developer tank 19y is replenished with the yellow developer 16y which is supplied from a toner cartridge (not shown) according to a consumption situation of the yellow developer 16y. In the embodiment, the developer tank 19 has been filled with magnetic carrier in advance. The magnetic carrier is mixed with a yellow toner supplied to the developer tank 19y, resulting in the yellow developer (a yellow two-component developer) 16y. A form of the developer is however not limited to the above form of two-component developer, and a form of one-component developer containing yellow toner only is also applicable. The stirring rollers 20y and 30y are screw-shaped members which are supported so as to be rotatable about respective axial line thereof in the internal space of the developer tank 19y. The stirring roller 20y is disposed so as to come into pressure-contact with the surface of the developing roller 17y. The stirring rollers 20y and 30y respectively rotate to thereby supply the yellow developer 16y which is supplied from the toner cartridge into the developer tank 19y, to a vicinity of the surface of the developing roller 17y. In the developing device 14y, the yellow developer 16y which has been formed by attaching the yellow toner to the magnetic carrier in the developer tank 19y, is supplied by the stirring rollers 20y and 30y to the surface of the developing roller 17y on which a developer layer is thereby formed. A thickness of the developer layer is homogenized by the developing blade 18y and then, from the developer layer, the yellow developer 16y is selectively supplied to the electrostatic latent image on the surface of the photoreceptor drum 11y by using a difference in potential, resulting in a yellow toner image corresponding to the yellow image information.

The drum cleaner 15y removes and thus collects the yellow developer 16y which remains on the surface of the photoreceptor drum 11y after the yellow toner image has been transferred from the surface of the photoreceptor drum 11y to the intermediate transfer belt 21 as will hereinafter be described. In the image forming unit 10y, the light scanning unit 13 irradiates the surface of photoreceptor drum 11y which has been charged by the charging roller 12y, with the signal light (laser light) 13y corresponding to the yellow image information, thereby forming the electrostatic latent image which is then developed with the yellow developer 16y supplied thereto from the developing device 14y, with the result that the yellow toner image is formed. The yellow toner image is transferred to the intermediate transfer belt 21 which comes into pressure-contact with the surface of the photoreceptor drum 11y and rotates in a direction of an arrow 29 as will hereinafter be described. The yellow developer 16y remaining on the surface of the photoreceptor drum 11y is removed and thus collected by the drum cleaner 15y. This image (toner image) forming operation is repeatedly carried out. The image forming units 10m, 10c, and 10b respectively have the configurations corresponding to the image forming unit 10y except that a magenta toner, a cyan toner, or a black toner is used respectively instead of the yellow toner. Descriptions of the image forming units 10m, 10c, and 10b will be thus omitted by giving the same reference symbols as those in the image forming unit 10y, which symbols will be followed respectively by “m” indicative of magenta, “c” indicative of cyan, and “b” indicative of black.

The toner contains binder resin, a colorant, and a release agent. As the binder resin, ingredients customarily used in this field can be used including polystyrene, a homopolymer of styrene substitute, a styrene-type copolymer, polyvinyl chloride, polyvinyl acetate, polyethylene, polypropylene, polyester, and polyurethane. The binder resin may be used alone, or two or more thereof may be used in combination. Among the above kinds of binder resin, for the color toner, preferable is the binder resin which has a softening temperature of 100° C. to 150° C. and a glass transition temperature of 50° C. to 80° C., and particularly preferable is polyester which has a softening temperature and a glass transition temperature in the above ranges, from the aspect of storage stability, durability, etc. Polyester in a soften or fused state is high in transparency. In the case where polyester is used as the binder resin, when a multicolor toner image composed of combined toner images of yellow, magenta, cyan, and black, is fixed on a recording medium 8, the polyester itself becomes transparent, leading to sufficient color development by subtractive color mixture. As the colorant, it is possible to use pigments and dyes for toner which have been conventionally used in the electrophotographic image forming technique. Examples of the pigment include an organic pigment such as azo pigment, benzimidazolone pigment, quinacridone pigment, phthalocyanine pigment, isoindolinone pigment, isoindoline pigment, dioxazine pigment, anthraquinone pigment, perylene pigment, perynone pigment, thioindigo pigment, quinophthalone pigment, or metal complex pigment; an inorganic pigment such as carbon black, titanium oxide, molybdenum red, chrome yellow, titanium yellow, chrome oxide, or Berlin blue; and metal powder such as aluminum powder. The pigment can be used alone, or two or more thereof may be used in combination. As the release agent, wax can be used, for example. It is possible to use the wax which is customarily used in this field including polyethylene wax, polypropylene wax, and paraffin wax. The toner may contain, other than the binder resin, colorant, and release agent, one or two or more additives for general use in toner, such as a charge control agent, a fluidity improving agent, a fixing promoting agent, and a conductive agent.

The toner can be manufactured according to the heretofore known methods such as a pulverization method, a suspension polymerization method, and an emulsification coagulation method. In the pulverizing method, the colorant, the release agent, etc. are molten and kneaded together with the binder resin, followed by pulverization. In the suspension polymerization method, the colorant, the release agent, a monomer of the binder resin, etc. are evenly dispersed, followed by polymerization of the monomer of the binder resin. In the emulsification coagulation method, binder resin particles, the colorant, the release agent, etc., are coagulated with the aid of a coagulant, and fine particles of a thus-obtained coagulated product are heated. A volume average particle diameter of the toner is not particularly limited, and a preferable diameter thereof falls in a range of from 2 μm to 7 μm. When the volume average particle diameter of the toner is less than 2 μm, the toner may be degraded in fluidity, leading to insufficient supply, stirring, and charging of the toner upon the developing operation. This may cause a shortage of the toner amount, an increase of toner of reverse polarity, and the like problem, which possibly leads to a failure in forming high-quality images. When the volume average particle diameter of the toner exceeds 7 μm, a larger amount of the toner particles has such a large diameter that a center part of each toner particle is hard to be soften, with the result that a fixing property of the image onto the recording medium 8 is degraded and moreover, the color development of the image is lower. And particularly in the case of fixing the image onto an OHP sheet, an obtained image is darker.

In the embodiment, the toner except the pigment has the same configuration as follows. The toner is a negatively-charged nonmagnetic insulating toner which has a glass transition temperature of 60° C., a softening temperature of 120° C., and a volume average particle diameter of 6 μm. When using the toner to obtain an image having an image density of 1.4 measured through a reflection densitometer type 310 manufactured by X-Rite Co., a required toner amount is 5 g/m². The toner contains polyester (the binder resin) having a glass transition temperature of 60° C. and a softening temperature of 120° C., a low-molecular polyethylene wax (the release agent) having a glass transition temperature of 50° C. and a softening temperature of 70° C., and pigments of respective colors. A content of the wax is 7% by weight of the total amount of the toner while a content of the pigment is 12% by weight of the total amount of the toner, with the binder resin, i.e., polyester which occupies a remaining part of the total amount of the toner. The low-molecular polyethylene wax contained in the toner is wax whose glass transition temperature and softening temperature are lower than those of the polyester serving as the binder resin.

The intermediate transfer section 3 includes the intermediate transfer belt 21, intermediate transfer rollers 22y, 22m, 22c, and 22b, supporting rollers 23, 24, and 25, and a belt cleaner 26. The intermediate transfer belt 21 is an endless belt-shaped toner image bearing member which is tensioned between the supporting rollers 23, 24, and 25 to form a loop-like travel path. The intermediate transfer belt 21 rotates in the direction of the arrow 27 at a velocity which is substantially the same as those of the photoreceptor drums 11y, 11m, 11c, and 11b. For the intermediate transfer belt 21, a 100 μm-thick polyimide film can be used, for example. A material of the intermediate transfer belt 21 is not limited to polyimide, and it is possible to use a film made of synthetic resin such as polycarbonate, polyamide, polyester, and polypropylene, or a film made of various rubbers. In the film made of the synthetic resin or the various rubbers, a conductive material such as furnace black, thermal black, channel black, or graphite carbon, is blended in order to adjust an electric resistance value of the intermediate transfer belt 21. A toner image bearing surface 21a of the intermediate transfer belt 21 comes into pressure-contact with the photoreceptor drums 11y, 11m, 11c, and 11b in the order just stated from the upstream side in the rotational direction of the intermediate transfer belt 21. Positions where the intermediate transfer belt 21 comes into pressure-contact with the photoreceptor drums 11y, 11m, 11c, and 11b, are positions where toner images of respective colors are transferred. The intermediate transfer rollers 22y, 22m, 22c, and 22b are arranged at positions which are respectively opposed to the photoreceptor drums 11y, 11m, 11c, and 11b via the intermediate transfer belt 21.

The intermediate transfer rollers 22y, 22m, 22c, and 22b are roller-shaped members which are respectively opposed to the photoreceptor drums 11y, 11m, 11c, and 11b via the intermediate transfer belt 21 and come into pressure-contact with a reverse side of the toner image bearing surface 21a of the intermediate transfer belt 21 and which are disposed so as to be rotatable about respective axial line of the rollers by a driving mechanism (not shown). For each of the intermediate transfer rollers 22y, 22m, 22c, and 22b, a roller-shaped member is used, for example, which is composed of a metallic shaft and a conductive layer covering a surface of the metallic shaft. The shaft is, for example, formed of a metal such as stainless steel. A diameter of the shaft is not particularly limited, and preferably from 8 mm to 10 mm. The conductive layer is formed of a conductive elastic body or the like material. As the conductive elastic body, a material customarily used in this field is applicable including, for example, ethylene-propylene-diene rubber (EPDM), foamed EPDM, and urethane foam, which contain a conductive material such as carbon black. Owing to the conductive layer, high voltage is evenly applied to the intermediate transfer belt 21. Since the toner images formed on the surfaces of the photoreceptor drum 11y, 11m, 11c, and 11b are transferred onto the intermediate transfer belt 21, intermediate transfer bias is applied to the intermediate transfer rollers 22y, 22m, 22c, and 22b through a constant voltage control, which bias has a polarity reverse to that of the polarity of the charged toner. By so doing, the toner images of yellow, magenta, cyan, and black formed on the photoreceptor drums 11y, 11m, 11c, and 11b are sequentially transferred and overlaid on top of one another on the toner image bearing surface 21a of the intermediate transfer belt 21, thus forming a multicolor toner image. Note that in the case where image information of only part of yellow, magenta, cyan, and black is inputted, a toner image is formed by only an image forming unit corresponding to a color of inputted image information, among the image forming units 10y, 10m, 10c, and 10b.

The supporting rollers 23, 24, and 25 are disposed so as to be rotatable about respective shaft centers thereof by a driving mechanism (not shown). The intermediate transfer belt 21 is stretched out and rotated in the direction of the arrow 27 by the supporting rollers 23, 24, and 25. For each of the supporting rollers 23, 24, and 25, an aluminum-made cylinder (a pipe-shaped roller) is used, for example, having a diameter of 30 mm and a thickness of 1 mm. The supporting roller 24 comes into pressure-contact with a later-described secondary transfer roller 28 via the intermediate transfer belt 21, thus forming a secondary transfer nip portion, and is electrically grounded. The supporting roller 24 has a function of stretching out the intermediate transfer belt 21 together with a function of secondarily transferring the toner image on the intermediate transfer belt 21 onto the recording medium 8.

The belt cleaner 26 is a member for removing the toner which remains on the toner image bearing surface 21a after the toner image on the toner image bearing surface 21a of the intermediate transfer belt 21 is transferred onto the recording medium 8 in the later-described secondary transfer section 4. The belt cleaner 26 is disposed opposite to the supporting roller 25 via the intermediate transfer belt 21. The belt cleaner 26 includes a cleaning blade 26a and a toner storing container 26b. The cleaning blade 26a is a platy member which comes into pressure-contact with the toner image bearing surface 21a of the intermediate transfer belt 21 by a pressure section (not shown) and scrapes off the residual toner, etc. on the toner image bearing surface 21a. As the cleaning blade 26a, it is possible to use a blade made of a rubber material (e.g. urethane rubber) having elasticity, for example. The toner storing container 26b serves to temporarily store the toner etc. scraped off by the cleaning blade 26a.

In the intermediate transfer section 3, the toner images formed on the photoreceptor drums 11y, 11m, 11c, and 11b are transferred and thus overlaid on top of one another at predetermined positions on the toner image bearing surface 21a of the intermediate transfer belt 21, thus forming a toner image. The toner image is secondarily transferred onto the recording medium 8 in the secondary transfer nip portion as described later. The toner, offset toner, paper dust, etc. which remain on the toner image bearing surface 21a of the intermediate transfer belt 21 after the secondarily-transferring operation, are removed by the belt cleaner 26. And onto the toner image bearing surface 21a, a toner image is transferred again.

The secondary transfer section 4 includes the supporting roller 24 and the secondary transfer roller 28. The secondary transfer roller 28 is a roller-shaped member which is disposed in pressure-contact with the supporting roller 24 via the intermediate transfer belt 21 and so as to be rotatable about an axial line of the member and which rotates by a driving mechanism (not shown). The secondary transfer roller 28 is composed of, for example, a metallic shaft and a conductive layer covering a surface of the metallic shaft. The shaft is, for example, formed of a metal such as stainless steel. The conductive layer is formed of a conductive elastic body or the like material. As the conductive elastic body, a material customarily used in this field is applicable including, for example, EPDM, foamed EPDM, and urethane foam, which contain a conductive material such as carbon black. The secondary transfer roller 28 is connected to a power source (not shown), and high voltage having a polarity opposite to the polarity of the charged toner is evenly applied to the secondary transfer roller 28. A pressure-contact area among the supporting roller 24, the intermediate transfer belt 21, and the secondary transfer roller 28 is a secondary transfer nip portion. In the secondary transfer section 4, the toner image on the intermediate transfer belt 21 is conveyed to the secondary transfer nip portion, and in synchronization therewith, the recording medium 8 which is fed from the later-described recording medium supplying section 5, is conveyed to the secondary transfer nip portion where the toner image and the recording medium 8 are thus stacked on each other so that the toner image is secondarily transferred onto the recording medium 8. By so doing, an unfixed toner image is borne on the recording medium 8. The recording medium 8 bearing an unfixed toner image is conveyed to the fixing apparatus 6.

The recording medium supplying section 5 includes a recording medium cassette 42, a pickup roller 43, and registration rollers 44a and 44b. The recording medium cassette 42 stores the recording medium 8. Specific examples of the recording medium 8 include plain paper, coated paper, paper only for color copy, a film for OHP (overhead projector), and a post card. Size of the recording medium 8 includes A4, A3, B5, B4, and a postcard size. The pickup roller 43 feeds the recording medium 8 sheet by sheet to a conveyance path P. The registration rollers 44a and 44b are a pair of roller members which are disposed in pressure-contact with each other, and serve to feed the recording medium 8 to the secondary transfer nip portion in synchronization with conveyance of the multicolor toner image on the intermediate transfer belt 21 to the secondary transfer nip portion. In the recording medium supplying section 5, the recording medium 8 stored inside the recording medium cassette 42 is fed sheet by sheet to the conveyance path P by the pickup roller 43, and furthermore fed to the secondary transfer nip portion by the registration rollers 44a and 44b.

The fixing apparatus 6 includes a fixing roller 50, a pressure roller 60, an external heating section 70, and a cleaning section 80 as shown in FIG. 3 and FIG. 4. Note that illustrations of a thermistor 76 and a thermostat 77 are omitted in FIG. 4.

The fixing roller 50 is a roller-shaped member which is rotatably supported by a supporting portion (not shown) and which rotates at a predetermined velocity in a direction of an arrow 56 by a driving mechanism (not shown). The fixing roller 50 is used to heat and thus fuse the toner constituting the toner image borne on the recording medium 8 so that the toner is fixed on the recording medium 8. In the embodiment, as the fixing roller 50, a roller-shaped member is used which is composed of a metal core 51, an elastic layer 52, and a surface layer 53. A usable metal for forming the metal core 51 is a metal having high thermal conductivity such as aluminum and iron. Shape examples of the metal core 51 include a cylindrical shape, a columnar shape, and the like shape etc., and preferable is the cylindrical shape which discharges a small amount of heat from the metal core 51. For constituting the elastic layer 52, any material having rubber elasticity may be used without particular limitation, and preferably used is a material which is also excellent in heat resistance. Specific examples of such a material include silicone rubber, fluoro-rubber, and fluorosilicone rubber. Among these materials, preferable is the silicone rubber which is particularly excellent in rubber elasticity. For constituting the surface layer 53, any material may be used without particular limitation as long as the material has excellent heat resistance and durability and weak adherence to the toner. Specific examples of the material of the surface layer 53 include a fluorine resin material such as PFA (tetrafluoroethylene-perfluoroalkylvinylether copolymer) and PTFE (polytetrafluoroethylene), and a fluoro-rubber. In the embodiment, the surface layer 53 is an about 30 μm-thick PFA layer. Inside the fixing roller 50, two heating portions 54 are provided. This aims to shorten a start-up time of the image forming apparatus 1 after turning on the power source thereof until a state ready for image formation is set, and prevent a surface temperature of the fixing roller 50 from lowering which is caused by heat transfer to the recording medium 8 in fixing the toner image. In the embodiment, a halogen lamp is used for the heating portion 54.

The pressure roller 60 is a roller-shaped member which is disposed so as to be rotatable in pressure-contact with the fixing roller 50 by a pressurizing mechanism (not shown), in downstream of the lowest point in a vertical direction of the fixing roller 50 in a rotational direction of the fixing roller 50. A pressure-contact area between the fixing roller 50 and the pressure roller 60 is a fixing nip portion 55. The pressure roller 60 is driven to rotate by rotation of the fixing roller 50. When the toner image is heated to be fixed onto the recording medium 8 by the fixing roller 50, the pressure roller 60 presses the fused toner onto the recording medium 8 to thereby promote the fixing of the toner image onto the recording medium 8. In the embodiment, as the pressure roller 60, a roller-shaped member having a diameter of 50 mm is used which is composed of a metal core 61, an elastic layer 62, and a surface layer 63. Usable materials for forming the metal core 61, the elastic layer 62, and the surface layer 63 are respectively the same metal or material which forms the metal core 51, elastic layer 52, and surface layer 53 of the fixing roller 50. Further, a shape of the metal core 61 is also the same as that in the case of the fixing roller 50. Inside the pressure roller 60, a heating portion 64 is provided. This aims to shorten the start-up time of the image forming apparatus 1 after turning on the power source thereof until the state ready for image formation is set, and prevent a surface temperature of the fixing roller 60 from drastically lowering which is caused by heat transfer to the recording medium 8 in fixing the toner image. In the embodiment, a halogen lamp is used for the heating portion 64.

The external heating section 70 includes a heating belt 71, a first pressure-contact roller 72, a second pressure-contact roller 73, the thermistor 76, and the thermostat 77. The heating belt 71 is an endless belt-shaped member which is tensioned between the first pressure-contact roller 72 and the second pressure-contact roller 73 to thereby form a loop-like travel path. Further, the heating belt 71 is arranged so as to contact with the fixing roller 50 in a band-shaped region which extends along a longitudinal direction of the fixing roller over a length in an outer circumferential direction of the fixing roller 50 from a pressure-contact point between the first pressure-contact roller 72 and the fixing roller 50 to a pressure-contact point between the second pressure-contact roller 73 and the fixing roller 50. Further, the heating belt 71 is driven to rotate in a direction of an arrow 78 by rotation of the fixing roller 50 in the direction of the arrow 56. As the heating belt 71, any belt can be used without particular limitation as long as the belt is excellent in heat-resistance and durability. Examples of the heating belt 71 include a polyimide-made belt and an electroformed nickel belt. A surface of the heating belt 71 may be provided with a fluorine resin layer which is made of PFA, PTFE, or the like material. In the embodiment, a 100 μm-thick endless belt is used which is formed into a cylindrical shape having a diameter of 31 mm.

The first pressure-contact roller 72 and the second pressure-contact roller 73 are roller-shaped members which are rotatably supported and disposed so as to come into pressure-contact with a surface of the fixing roller 50 via heating belt 71 by a pressure section (not shown). The first pressure-contact roller 72 and the second pressure-contact roller 73 are driven to rotate by rotation of the heating belt 71 in the direction of the arrow 78. As the first pressure-contact roller 72 and the second pressure-contact roller 73, metallic rollers can be used, each of which is made of a metal having high thermal conductivity such as aluminum and iron. On a surface of the metallic roller, a fluorine resin layer may be formed according to need. The first pressure-contact roller 72 and the second pressure-contact roller 73 contain therein heating portions 74 and 75, respectively. These heating portions heat the heating belt 71 and thus the fixing roller 50. The heating portions 74 and 75 are connected to a power source (not shown), and electric power is supplied to cause the heating portions 74 and 75 to generate heat. As the heating portions 74 and 75, a commonly-used heating device can be used. In the embodiment, a halogen lamp is used for each of heating portions 74 and 75. Note that the first pressure-contact roller 72 and the second pressure-contact roller 73 are disposed so as to have respective axial lines thereof in parallel with each other on the fixing roller 50 and so as to be distanced away from each other.

The thermistor 76 is disposed close to the heating belt 71 at a position which is opposed to the second pressure-contact roller 73 via the heating belt 71. The thermistor 76 detects a temperature of the heating belt 71. A result detected by the thermistor 76 is inputted to a control unit 31. On the basis of the result detected by the thermistor 76, the control unit 31 determines whether or not the temperature of the heating belt 71 falls in a set range. When the temperature of the heating belt 71 is lower than the set range, a control signal is sent to the power source to which the heating portions 74 and 75 are connected, and electric power is supplied to the heating portions 74 and 75 which are thus promoted to generate heat. When the temperature of the heating belt 71 is higher than the set range, the absence or presence of capability for power feeding to the heating portions 74 and 75 is checked. In the case where the power supply continues, a control signal for stopping the power supply is sent. The thermostat 77 is disposed opposite to the second pressure-contact roller 73 via the heating belt 71 and disposed close to the heating belt 71 at a position in downstream of the thermistor 76 in a rotational direction of the heating belt 71. The thermostat 77 detects an abnormal temperature rise of the heating belt 71. A result detected by the thermostat 77 is inputted to the control unit 31. In accordance with the result detected by the thermostat 77, the control unit 31 stops the power supply from the power source to which the heating portions 74 and 75 are connected.

A fixing mechanism containing the fixing roller 50, the pressure roller 60, and the external heating section 70 is controlled by the control unit 31 which controls an entire operation of the image forming apparatus 1. In response to an input of command for image formation, the control unit 31 sends a control signal to the power source (not shown) for supplying electric power to the heating portions 54, 64, 74, and 75 which are provided respectively inside the fixing roller 50, the pressure roller 60, the first pressure-contact roller 72, and the second pressure-contact roller 73. The command for image formation is inputted from an operation panel (not shown) which is disposed on a top surface in a vertical direction of the image forming apparatus 1, or an external equipment such as a computer which is connected to the image forming apparatus 1. The power source which has received the control signal, supplies electric power to activate the heating portions 54, 64, 74, and 75. The heating portions 54, 64, 74, and 75 respectively heat the heating roller 50, the pressure roller 60, and the surface of the heating belt 71, up to the respective set temperatures. A temperature detecting sensor (not shown) is disposed near the fixing roller 50 and the pressure roller 60, and detects that temperatures of the above components have reached the set temperatures. An input of such a detected result to the control unit 31 causes the control unit 31 to send a control signal to a driving mechanism (not shown) for rotating the fixing roller 50, thereby driving the fixing roller 50 to rotate in the direction of the arrow 56. This also drives the pressure roller 60 and thus the heating belt 71. In this state, the recording medium 8 bearing the unfixed toner image is conveyed from the secondary transfer section 4 to the fixing nip portion 55. When the recording medium 8 passes through the fixing nip portion 55, the toner constituting the toner image is heated and pressurized to be thereby fixed on the recording medium 8, resulting in an image.

The cleaning section 80 includes a web 81, a feeding roller 82, a web pressure-contact roller 83, and a winding roller 84. The cleaning section 80 serves to remove the offset toner, etc. attached to the fixing roller 50 and the surface of the heating belt 71.

The web 81 is provided so as to be fed in a direction of an arrow 87 from the feeding roller 82 toward the web pressure-contact roller 83 and hung around the web pressure-contact roller 83 to thereby come into pressure-contact with the surface of the fixing roller 50, thereafter being taken up by the winding roller 84. A pressure-contact portion between the web 81 and the surface of the fixing roller 50 is a first cleaning nip portion 85. Further, the web 81 is arranged so as to contact with the surface of the heating belt 71 by being pressed thereon in a state where the web 81 is tensioned between the feeding roller 82 and the web pressure-contact roller 83 without slack. Such an arrangement can be easily achieved by appropriately selecting an arrangement of the feeding roller 82, the web pressure-contact roller 83, and the heating belt 71. This configuration enables the web 81 to contact with the heating belt 71 without providing a pressure-contact member which brings the web 81 into pressure-contact with the heating belt 71. A pressure-contact area between the web 81 and the heating belt 71 is a second cleaning nip portion 86. The web 81 has a surface which is unflossy and dense, resulting in high cleaning ability (toner-removing ability), and a rear surface which is flossy and rough, resulting in low cleaning ability, attributable to manufacturing problems of the web. Accordingly, in the configuration of the invention, the surface of the web 81 comes into pressure-contact with the fixing roller 50 and the heating belt 71 at the first cleaning nip portion 85 and the second cleaning nip portion 86. That is to say, the same surface of the web 81 comes into pressure-contact with the fixing roller 50 and the heating belt 71. This configuration enables the fixing roller 50 and heating belt 71 to be cleaned by only the surface of web 81 which exhibits excellent cleaning performance, resulting in no need to use the rear surface of the web 81. In addition, a suspension mechanism of the web 81 is simplified, thus effectively preventing the fixing apparatus 6 from growing in size.

In the embodiment, despite such a configuration that the web 81 comes into pressure-contact with the heating belt 71 and then comes into pressure-contact with the fixing roller 50, the fixing roller 50 may not be contaminated by the toner removed from the heating belt 71. The toner on the heating belt 71 is fused by heat to thereby exhibit adherence, and therefore be attached to the web 81 and thus removed almost for certain. And an amount of the toner attached to the heating belt 71 is very small and moreover, the toner is firmly stuck to the web 81 and decreased in adherence while conveyed by the web 81 from the second cleaning nip portion 86 to the first cleaning nip portion 85. The toner is therefore not attached to the fixing roller 50. Even if the toner on the heating belt 71 is attached to the fixing roller 50, such an amount of the attached toner is so small that the cleaning ability of the web 81 is not substantially degraded. Consequently, the surface of the fixing roller 50 can also be sufficiently cleaned.

For the web 81, a heat-resistant nonwoven fabric can be used, for example. No particular limitation is imposed on selection of the heat-resistant nonwoven fabric, and a specific example thereof is a nonwoven fabric which contains an aromatic polyamide fiber and a polyester fiber that softens at high temperature and which has both of adequate flexibility and mechanical strength. The nonwoven fabric as just described is commercially available, including Nomex (trade name) and Himeron (product name). Further, a thickness of the web 81 is not particularly limited, and preferably from 30 μm to 100 μm. In the embodiment, a 40 μm-thick web is used as the web 81. Moreover, the web 81 may be impregnated with oil which has a mold-releasing effect. As the oil, the oil customarily used in this field can be used including silicone oil such as dimethyl silicone oil, amino-modified silicone oil, mercapto-modified silicone oil, and fluoro-modified silicone oil. In the embodiment, the web 81 is impregnated with silicone oil whose viscosity is around 0.01 m²/s (10,000 centistokes, 25° C.).

The feeding roller 82 is supported so as to be capable of being driven to rotate about an axial line thereof. The feeding roller 82 holds the web 81 which is taken up on a surface of the feeding roller 82. In the embodiment, the feeding roller 82 is disposed above the external heating section 70 in the vertical direction so that the feeding roller 82 is distanced away from the external heating section 70 and opposed to the fixing roller 50 via the external heating section 70. In particular, the feeding roller 82 is disposed preferably so that a shaft center of the feeding roller 82 is closer to the second pressure-contact roller 73 than a shaft center of the first pressure-contact roller 72 is in the horizontal direction. The configuration just stated will bring the web 81 and the heating belt 71 into pressure-contact with each other more reliably and also prevent the fixing apparatus 6 from growing in size. Further, in the embodiment, the feeding roller 82 is configured so as to be driven to rotate in a counterclockwise direction to reel out the web 81. In the configuration, as shown in FIG. 4, a feeding position where the web 81 is fed from the feeding roller 82 is shifted away from the second cleaning nip portion 86 (or downward in the vertical direction), that is, in a direction of an arrow 90 as an amount of the web 81 taken up by the winding roller 84 increases. And at the second cleaning nip portion 86, an angle formed by the web 81 and the heating belt 71 gradually becomes smaller. As a result, a contact width d gradually becomes longer between the web 81 and the heating belt 71 in a travel direction of the web 81 or the heating belt 71. As the fixing operation proceeds, an amount of the toner attached to the heating belt 71 becomes larger than the amount at the onset of the fixing operation, with the result that the gradual increase of the contact area between the web 81 and the heating belt 71 enables highly effective cleaning of the surface of the heating belt 71.

The web pressure-contact roller 83 is a roller-shaped member whose both ends in a longitudinal direction are pivotally supported by bearings (not shown) so as to be capable of being driven to rotate. The web pressure-contact roller 83 is disposed below the first pressure-contact roller 72 in a vertical direction thereof, so as to come into pressure-contact with the surface of the fixing roller 50 via the web 81 by a press portion (not shown). The web pressure-contact roller 83 is driven to rotate when the winding roller 84 operates to take up the web 81. As the web pressure-contact roller 83, a roller-shaped member is used, for example, which is composed of a metal core and an elastic layer formed on a surface of the metal core. An elastic material constituting the elastic layer may be, for example, heat-resistant rubber such as silicone rubber or foam thereof. Surface hardness of the elastic layer is not particularly limited, and preferably 20° to 300 (Asker-C). Further, a press force onto the fixing roller 50 preferably falls in a range of from 3793.6 Pa (0.039 kgf/cm²) to 18967.9 Pa (0.19 kgf/cm²). The press force smaller than 3793.6 Pa may cause the offset toner to leak inside the image forming apparatus 1. The press force larger than 18967.9 Pa may cause the surface layer of the fixing roller 50 to be easily damaged to result in a rise of defective fixing of an image, or the like problem. For the press portion, a spring member is used, for example. A longitudinal width of the web pressure-contact roller 83 is preferably set to be longer than a maximum width of a region for image formation where an image is to be formed in the image forming apparatus 1. Further, the cleaning performance of the cleaning section 80 largely depends on a width (a cleaning nip width) of each of the first cleaning nip portion 85 and the second cleaning nip portion 86, and it is therefore preferable to set the cleaning nip width within a proper range. The cleaning nip width is determined mainly based on the press force of the web pressure-contact roller 83 onto the fixing roller 50, a roller diameter of the web pressure-contact roller 83, and the like element. In the embodiment, the web pressure-contact roller 83 is designed to have a longitudinal width of 310 mm which is longer than the width of the region for image formation, and a roller diameter of 20 mm.

The winding roller 84 is supported so as to be rotatable about an axial line thereof by a driving mechanism (not shown) and serves to take up the web 81 which has contacted with the fixing roller 50. In the embodiment, the winding roller 84 is disposed above the web pressure-contact roller 83 in the vertical direction, so as to be distanced away from the feeding roller 82 and the external heating section 70. This enables to prevent the fixing apparatus 6 from growing in size. The rotation of the winding roller 84 causes the web 81 to be fed in the direction of the arrow 87 from the feeding roller 82, starting the cleaning operation. The operation of the cleaning section 80 is controlled by the control unit 31. Using a sensor, a rotation number of the fixing roller 50, and the like element, the control unit 31 detects that the predetermined number of the recording medium 8 has passed through the fixing nip portion 55. The control unit 31 then sends a control signal to a driving mechanism (not shown) (which is, in this case, a motor provided inside a main body of the image forming apparatus 1). The driving mechanism which has received the control signal, operates to rotate the winding roller 84 to thereby take up the predetermined amount of the web 81. This winding operation will cause the web 81 to be fed in the direction of the arrow 87 from the feeding roller 82. The web 81 cleans the heating belt 71 and the surface of the fixing roller 50 by sequentially passing through the second cleaning nip portion 86 and the first cleaning nip portion 85 to thus collect the offset toner which exists on the heating belt 71 and the surface of the fixing roller 50. At the same time, the web 81 supplies the oil to the heating belt 71 and the fixing roller 50. And then, the web 81 goes around the web pressure-contact roller 83 and is taken up by the winding roller 84. Note that although the winding operation is carried out by the winding roller 82 at intervals in the above described example of operation, the configuration is not limited to such an example of operation, and a continuous winding operation may be carried out at the right time when the recording medium 8 passes through the fixing nip portion 55.

In the fixing apparatus 6, the cleaning section 80 carries out the cleaning operation of the fixing roller 50 and the heating belt 71 in tandem with the fixing operation of the toner image onto the recording medium 8 conducted by the fixing roller 50 and the pressure roller 60. Accordingly, even when the continuous image forming process is carried out at high speed, the decrease of the surface temperature of the fixing roller 50, the attachment of the offset toner onto the fixing roller 50, and the like trouble are reliably prevented from occurring. A given image can be thus formed with high quality without causing defects in the fixing, image, etc.

The scanner section 7 includes a document table 41, a light source (not shown), and a CCD sensor 9. On a top surface of the document table 41 is placed a document which is to be copied. For the document table 41, a platy member is used which is made of a transparent material such as transparent glass. The light source is used to illuminate the document placed on the document table 41. The CCD sensor 9 photoelectrically converts the light which is reflected on the document illuminated by the light source, thereby converting the reflected light to image information (image signal). The CCD sensor 9 includes a conversion portion, a transfer portion, and an output portion. The conversion portion converts a light signal in form of the reflected light to an electric signal. The transfer portion sequentially transfers the electric signal to the output portion in synchronization with a clock pulse. The output portion converts the electric signal to a voltage signal which is then amplified and adjusted to be lower in impedance, thereafter outputting the voltage signal. An analog signal thus obtained is converted to a digital signal through a widely-known image process. The image information of the document read by the scanner section 7 is sent to the control unit 31 which controls the entire operation of the image forming apparatus, and then treated with various image processes, thereafter being stored once in a memory. According to an output command, the image stored in the memory is read out and transferred to the light scanning unit 13 to thereby form an image on the recording medium 8, i.e., a recording sheet.

The image forming apparatus 1 is provided with the control unit 31. The control unit 31 is disposed in an upper part of internal space of the image forming apparatus 1. The control unit 31 includes a storage portion, a calculation portion, and a control portion. In the storage portion are written, for example, a print command inputted by way of an operation panel disposed on the top surface of the image forming apparatus 1, a result detected by various sensors disposed in various parts inside the image forming apparatus 1, image information inputted from an external equipment, various set values and data table which are used to control the operations of various components inside the image forming apparatus 1, and a program for performing the various controls. For the storage portion, a device customarily used in this field can be used including, for example, a read only memory (ROM), a random access memory (RAM), and a hard disc drive (HDD). For the external equipment, an electrical and electronic equipment can be used which can form or obtain image information and which can be electrically connected to the image forming apparatus. Specific examples of the external equipment include a computer and a digital camera. The calculation portion takes out the various data (the print command, the detected result, the image information, etc.) inputted in the storage portion, and the program for performing the various controls. On the basis of the above various data and program, the calculation portion conducts various detection and/or determination. According to various results of determination and computational decisions obtained by the calculation portion, the control portion sends a control signal to a relevant device to control an operation thereof. The control portion and the calculation portion are, for example, process circuits which are realized by a microcomputer, a microprocessor, etc. having a central processing unit (CPU). The control unit 31 includes a main power source together with the storage portion, the calculation portion, and the control portion. The main power source supplies electric power to not only the control unit 31 but also the various devices inside the image forming unit 1.

In the image forming apparatus 1, the toner images of the respective colors formed on the photoreceptor drum 11y, 11m, 11c, and 11b in the toner image forming section 2 are transferred and overlaid on the intermediate transfer belt 21 in the intermediate transfer section 3, thereby forming a multicolor toner image. The multicolor toner image is transferred to the recording medium 8 in the secondary transfer section 4. The recording medium 8 bearing the multicolor toner image not yet fixed thereon is introduced to the fixing nip portion of the fixing apparatus 6 where the recording medium 8 is heated and pressurized so that the multicolor toner image is fixed on the recording medium 8, thus forming a color image. At this time, the offset toner, etc. are reliably removed by the cleaning section 80 from the fixing roller 50 and the surface of the external heating section 70. Accordingly, even when the image forming process speed increases, image defects can be prevented from appearing which result from the defective fixing, the attachment of the offset toner onto the recording medium 8, and the like cause.

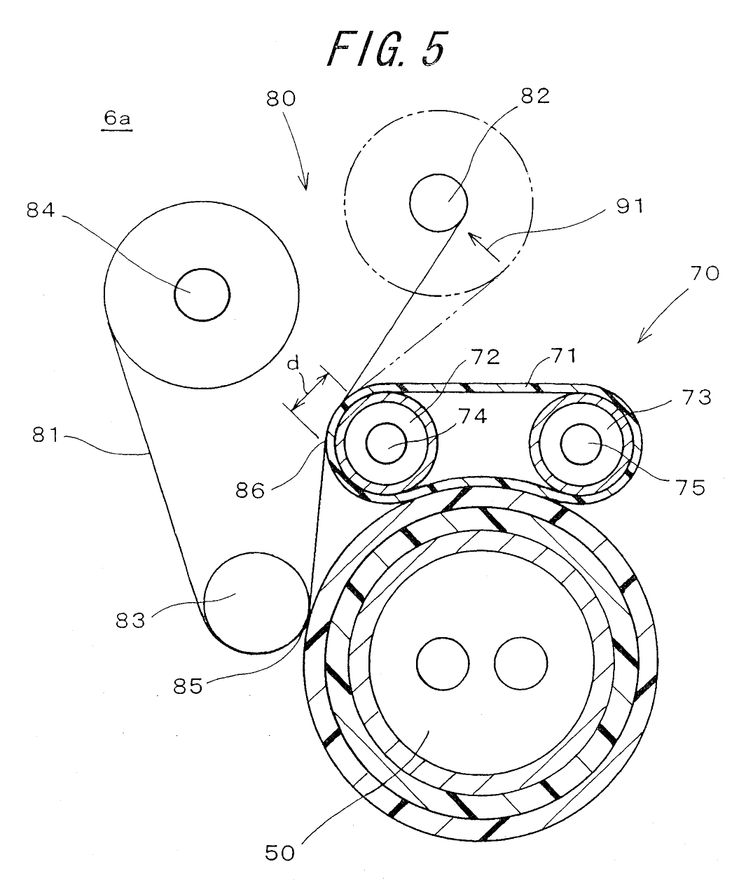

FIG. 5 is a sectional view schematically showing a configuration of a fixing apparatus 6a according to a second embodiment. The fixing apparatus 6a is similar to the fixing apparatus 6, and corresponding parts will be denoted by the same reference numerals, and descriptions thereof will be omitted. The fixing apparatus 6a is characterized in that the feeding roller 82 is driven to rotate in a clockwise direction to feed the web 81, and a rest of the configuration of the fixing apparatus 6a is the same as that of the fixing apparatus 6. In the configuration of the fixing apparatus 6a, a feeding position where the web 81 is fed from the feeding roller 82 is shifted upward in the vertical direction, that is, a direction of an arrow 91, as an amount of the web 81 taken up by the winding roller 84 increases. As a result, an angle formed by the web 81 and the heating belt 71 gradually becomes larger at the second cleaning nip portion 86. A contact width d gradually becomes shorter between the web 81 and the heating belt 71 in a travel direction of the web 81 or the heating belt 71. Also in the configuration as just stated, the fixing roller 50 and the heating belt 71 can be sufficiently cleaned.

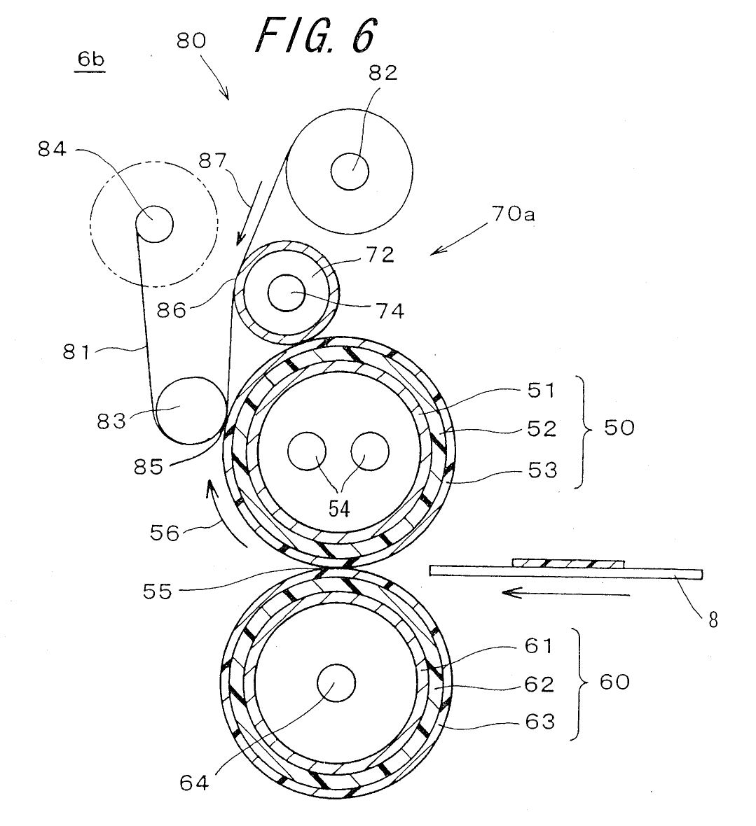

FIG. 6 is a sectional view schematically showing a configuration of a fixing apparatus 6b according to a third embodiment of the invention. The fixing apparatus 6b is similar to the fixing apparatus 6, and corresponding parts will be denoted by the same reference numerals, and descriptions thereof will be omitted. The fixing apparatus 6b has the same configuration as that of the fixing apparatus 6 except that the fixing apparatus 6b includes an external heating section 70a instead of the external heating section 70. The external heating section 70a includes a first pressure-contact roller 72. The first pressure-contact roller 72 has the same configuration as that of the first pressure-contact roller 72 disposed in the external heating section 70, and serves as a heating roller. The web 81 contacts with a surface of the first pressure-contact roller 72 by being pressed thereon in a state where the web 81 is tensioned between the feeding roller 82 and the web pressure-contact roller 83 without slack. Further, the web 81 is pressed by the web pressure-contact roller 83 to come into pressure-contact with the surface of the fixing roller 50. The web 81 thus comes into pressure-contact with both of the first pressure-contact roller 72 and the fixing roller 50 while the first pressure-contact roller 72 comes into pressure-contact with both of the fixing roller 50 and the web 81. The web 81 comes into pressure-contact with the first pressure-contact roller 72 to clean a surface thereof, and then comes into pressure-contact with the fixing roller 50 to clean a surface thereof. At the same time, the web 81 applies the oil to these surfaces. The configuration as just stated also enables adaptation to an increase in the image forming process speed and allows stable formation of high quality images without the defective fixing and image defects.

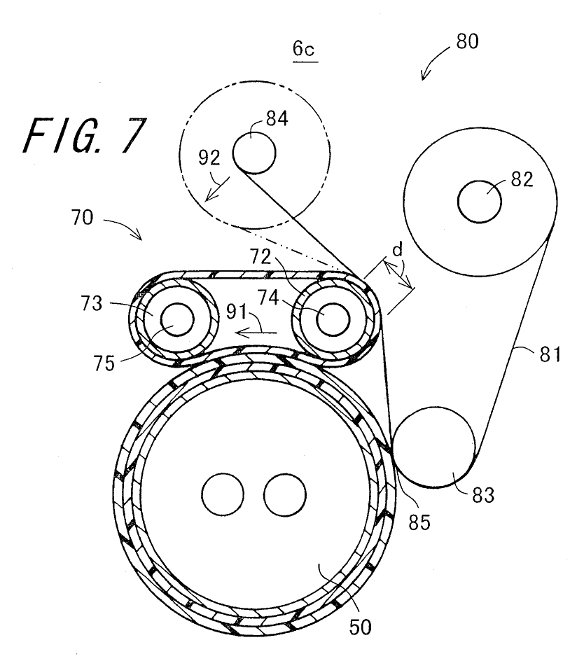

FIG. 7 is a sectional view schematically showing a fixing apparatus 6c according to a fourth embodiment of the invention. The fixing apparatus 6c is similar to the fixing apparatus 6, and corresponding parts will be denoted by the same reference numerals, and descriptions thereof will be omitted. In the fixing apparatus 6, the web pressure-contact roller 83 is disposed so as to come into pressure-contact with the surface of the fixing roller 50 via the web 81, upstream of the external heating section 70 in a rotational direction of the fixing roller 50. On the other hand, the fixing apparatus 6c is characterized in that the web pressure-contact roller 83 is disposed in downstream of the external heating section 70 in the rotational direction of the fixing roller 50. As a result, the web 81 comes into pressure-contact with the surface of the fixing roller 50 in downstream of the external heating section 70 in the rotational direction of the fixing roller 50. That is to say, the fixing apparatus 6c includes the web 81, the web pressure-contact roller 83 which comes into pressure-contact with the fixing roller 50 via the web 81 in downstream of the external heating section 70 in the rotational direction of the fixing roller 50, the feeding roller 82 which is disposed above the web pressure-contact roller 83 in the vertical direction, and the winding roller 84 which is disposed above the external heating section 70 in vertical direction. The above arrangement of the feeding roller 82, the web pressure-contact roller 83, and the winding roller 84 enables the configuration that the web 81 comes into pressure-contact with the surface of the fixing roller 50 and then comes into pressure-contact with the heating belt 71 which rotates in the direction of the arrow 91 in the external heating section 70.

In the configuration, the heating belt 71 catches contamination attached to the fixing roller 50, and the web 81 comes into pressure-contact with the heating belt 71 and thereby cleans a surface thereof sufficiently, with the result that a contamination level of the fixing roller 50 becomes very low into almost no contamination. In addition, although the web 81 having a toner attached thereto comes into contact with the heating belt 71 which toner has been removed from the fixing roller 50, the toner attached to the web 81 is not shifted to the heating belt 71. Reasons thereof includes, for example, 1) a mold-releasing property of the heating belt 71 is higher than that of the web 81; 2) the toner attached to the heating belt 71 exhibits strong adherence in a fused state since the heating belt 71 is usually heated to a melting temperature of the toner; and 3) a surface temperature of the web 81 is lower than a temperature of the heating belt 71. Hence, even in the configuration as above, only an irreversible shift of the toner from the heating belt 71 to the web 81 occurs, with the result that the fixing roller 50 and the heating belt 71 can be sufficiently cleaned.

In the embodiment, a mounting arrangement of the winding roller 84 is not particularly limited, and it is preferable that the web 81 be provided below a shaft of the winding roller 84 as shown in FIG. 7. In the configuration as just stated, a winding position where the web 81 is taken up by the winding roller 84 is shifted in a direction of an arrow (downward in the vertical direction) as an amount of the web 81 taken up by the winding roller 84 increases, as shown in FIG. 7. And at the second cleaning nip portion 86, an angle formed by the web 81 and the heating belt 71 gradually becomes smaller. As a result, the contact width d gradually becomes longer between the web 81 and the heating belt 71 in a travel direction of the web 81 or the heating belt 71. As the fixing operation proceeds, an amount of the toner attached to the heating belt 71 becomes larger than the amount at the onset of the fixing operation, with the result that the gradual increase of the contact area between the web 81 and the heating belt 71 enables highly effective cleaning of the surface of the heating belt 71.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A fixing apparatus comprising:
a fixing section disposed so as to be rotatable about an axis thereof, for fixing an unfixed toner image onto a recording medium by heating the recording medium bearing the unfixed toner image;
a pressure section disposed in pressure-contact with the fixing section so as to form a pressure-contact area therebetween, for pressurizing a recording medium bearing the unfixed toner image which is conveyed to the pressure-contact area;
an external heating section disposed so as to contact with a peripheral surface of the fixing section or the pressure section from outside, for heating the peripheral surface; and
a cleaning section including at least:
a cleaning web for cleaning a surface of the fixing section or the pressure section by contact with the surface,
a feeding roller for reeling out the cleaning web,
a web pressure-contact roller rotatably supported, for bringing the cleaning web into pressure-contact with the fixing section or the pressure section, and
a winding roller for taking up the cleaning web which has come into pressure-contact with the fixing section or the pressure section,
wherein the cleaning web contacts with the external heating section by being pressed thereon in a state where the cleaning web is tensioned between the feeding roller and the web pressure-contact roller.

2. The fixing apparatus of claim 1, wherein the external heating section comprises a heating roller which is disposed in pressure-contact with the fixing section or the pressure section.

3. The fixing apparatus of claim 1, wherein the external heating section comprises a belt member which is disposed in pressure-contact with the fixing section or the pressure section.

4. The fixing apparatus of claim 1, wherein the cleaning web is arranged so that one surface thereof contacts with the fixing section and the external heating section or the pressure section and the external heating section.

5. The fixing apparatus of claim 1, wherein the cleaning web is arranged so as to contact with the fixing section or the pressure section upstream of the external heating section in a rotational direction of the fixing section or the pressure section.

6. The fixing apparatus of claim 5, wherein the cleaning web is arranged so as to contact with the external heating section and then contact with the fixing section or the pressure section.

7. The fixing apparatus of claim 1, wherein the cleaning web is arranged so as to contact with the fixing section or the pressure section in downstream of the external heating section in a rotational direction of the fixing section or the pressure section.

8. The fixing apparatus of claim 7, wherein the cleaning web is arranged so as to contact with the fixing section or the pressure section and then contact with the external heating section.

9. The fixing apparatus of claim 1, wherein the cleaning web is arranged so that a contact area between the cleaning web and the external heating section increases as an amount of the cleaning web taken up by the winding roller increases.

10. An image forming apparatus comprising:
a photoreceptor having on a surface thereof a photosensitive layer;
a charging section for charging the surface of the photoreceptor;
an exposing section for forming an electrostatic latent image by irradiating the charged surface of the photoreceptor with signal light corresponding to image information;
a developing section for forming a toner image by supplying a toner to the electrostatic latent image on the surface of the photoreceptor;
a transfer section for transferring the toner image onto a recording medium by using or not using an intermediate transfer medium; and
the fixing section of claim 1 for fixing an unfixed toner image on the recording medium.
